(19) United States
(12) Patent Application Publication
(10) Pub. No.: US 2011/0246190 A1
(43) Pub. Date: Oct. 6, 2011

(54) SPEECH DIALOG APPARATUS

(75) Inventors: Kaoru SUZUKI, Kanagawa (JP); Tadashi AMADA, Tokyo (JP); Koichi YAMAMOTO, Tokyo (JP)

(73) Assignee: KABUSHIKI KAISHA TOSHIBA, Tokyo (JP)

(21) Appl. No.: 12/881,501

(22) Filed: Sep. 14, 2010

(30) Foreign Application Priority Data
Mar. 31, 2010 (JP) 2010-084328

(51) Int. Cl. G10L 21/02

(52) U.S. Cl. 704/226

(57) ABSTRACT

According to one embodiment, a speech dialog apparatus includes a speech detection unit that detects a start and an end of echo removed speech obtained by removing an echo of response speech contained in input speech; a response interruption control unit that outputs a response interruption command if the end is not yet detected when a predetermined period from the detection of the start passes; and a dialog control unit that causes a response speech output unit to interrupt output of the response speech upon receipt of the response interruption command from the response interruption control unit.

### CROSS-REFERENCE TO RELATED APPLICATIONS

This application is based upon and claims the benefit of priority from Japanese Patent Application No. 2010-084328, filed on Mar. 31, 2010; the entire contents of which are incorporated herein by reference.

### FIELD

Embodiments described herein relate generally to speech dialog processing.

### BACKGROUND

Technology that causes response speech to interrupt when an interrupt utterance by a user is detected while the response speech being output is disclosed in U.S. Pat. No. 5,155,760. According to the method of U.S. Pat. No. 5,155,760, the user does not have to continue to listen to response speech uselessly.

However, according to the method of U.S. Pat. No. 5,155,760, even when the user wants to continue to listen to response speech, the response speech may unintentionally be interrupted by erroneously detecting noise or the like as the start of utterance by the user.

### BRIEF DESCRIPTION OF THE DRAWINGS

FIG. 1 is a diagram illustrating a configuration of a speech dialog apparatus according to an embodiment;

FIG. 2 is a diagram illustrating a flow of processing of the speech dialog apparatus;

FIG. 3 is a diagram illustrating a conditional branching table of the speech dialog apparatus;

FIG. 4 is a diagram illustrating a timing chart of response speech interruption;

FIG. 5 is a diagram illustrating a configuration of an echo cancel unit;

FIG. 6 is a diagram illustrating a configuration of a speech dialog apparatus capable of selecting an interruption mode;

FIG. 7 is a diagram illustrating a flow of processing in interruption mode 1;

FIG. 8 is a diagram illustrating a flow of processing in interruption mode 3;

FIG. 9 is a diagram illustrating a configuration of a computer;

FIG. 10 is a diagram illustrating a configuration of a recording medium; and

FIG. 11 is a diagram illustrating a state transition of an automaton.

### DETAILED DESCRIPTION

In general, according to one embodiment, a speech dialog apparatus includes a speech detection unit that detects a start and an end of echo removed speech obtained by removing an echo of response speech contained in input speech; a response interruption control unit that outputs a response interruption command if the end is not yet detected when a predetermined period from the detection of the start passes; and a dialog control unit that causes a response speech output unit to interrupt output of the response speech upon receipt of the response interruption command from the response interruption control unit.

Exemplary embodiments of the speech dialog apparatus will be described with reference to appended drawings.

### First Embodiment

A speech dialog apparatus according to this embodiment determines that speech whose start and end are detected is not user speech but is noise when the end of speech is detected before a predetermined period T from the start of the speech passes, and does not interrupt response speech. Conversely, if the end of speech is detected for the first time after the predetermined period T from the start of the speech has passed, the speech dialog apparatus interrupts response speech determining that the speech whose start and end are detected is not noise but is user speech. Thus, while a function to interrupt response speech when the utterance of a user is started is realized, an occurrence of interruption of response speech due to erroneous detection of short noise as user speech can be reduced.

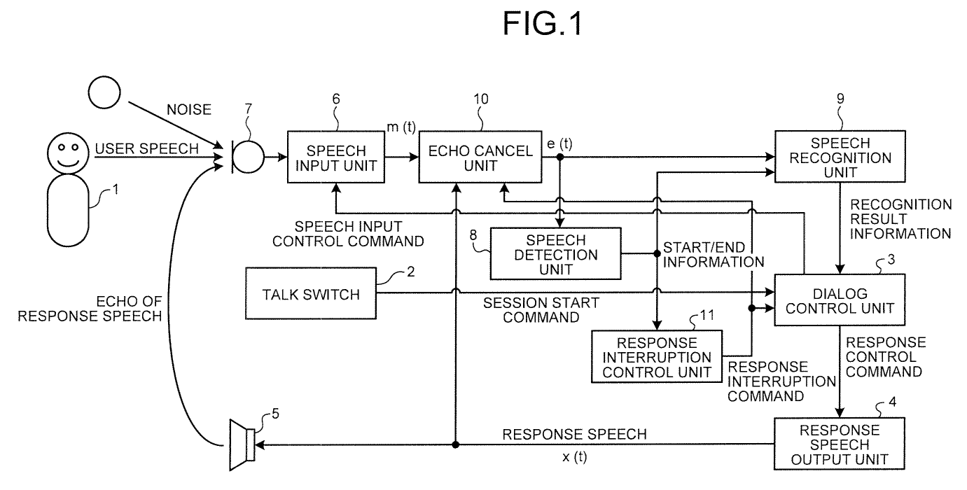

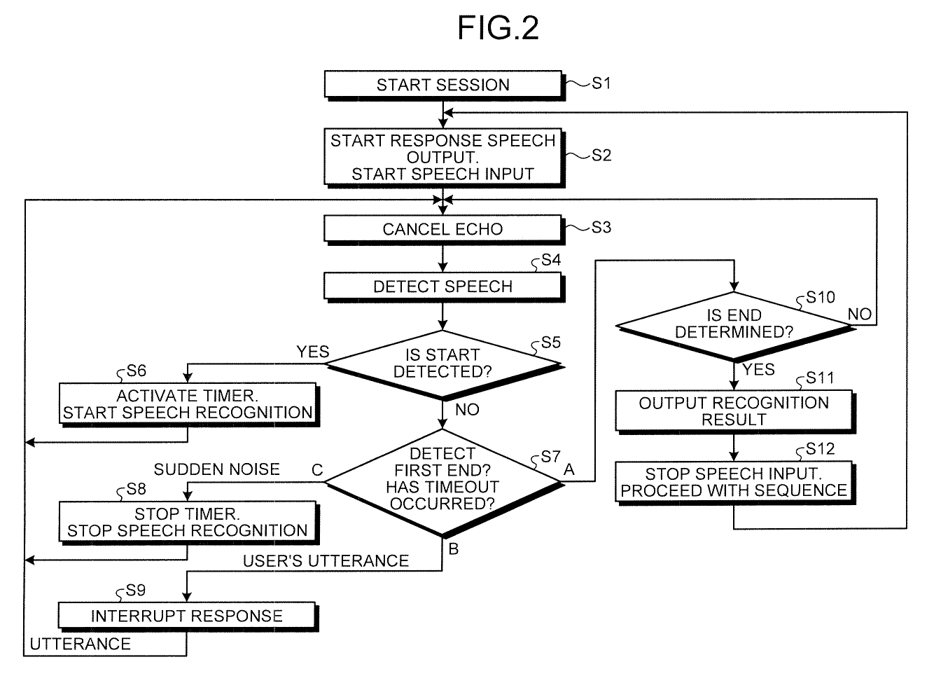

FIG. 1 is a diagram illustrating the configuration of a speech dialog apparatus according to the first embodiment. FIG. 2 is a diagram illustrating a flow chart representing an operation of the speech dialog apparatus according to the embodiment.

When a talk switch 2 is pressed by a user 1 and a session start command is sent to a dialog control unit 3 (step S1 in FIG. 2), the dialog control unit 3 sends, as needed and in accordance with a dialog sequence, a response control command to a response speech output unit 4, instructing output of response speech toward the user 1.

Upon receipt of the command, the response speech output unit 4 generates a signal x (t) of the instructed response speech. The signal x (t) is amplified and output from a speaker 5 toward the user 1.

At this point, the dialog control unit 3 sends a speech input control command instructing the start of speech input to a speech input unit 6. Upon receipt of the command, the speech input unit 6 starts speech input via a microphone 7 so that speech uttered by the user 1 can be input (step S2 in FIG. 2).

In conjunction with the input of speech by the speech input unit 6, an echo cancel unit 10 generates and outputs a signal e (t) that is a signal of echo removed speech obtained by canceling (removing), from a signal m (t) of microphone input speech by the speech input unit 6, an echo of the signal x (t) of the response speech (step S3 in FIG. 2).

A speech detection unit 8 calculates an evaluation value S from the signal e (t) of echo removed speech by the echo cancel unit 10 to determine whether the user 1 has uttered based on the evaluation value S. If the start or end of speech uttered by the user 1 is detected or determined, the speech detection unit 8 also sends start/end information representing the detection/determination to a speech recognition unit 9 and a response interruption control unit 11 (step S4 in FIG. 2). An acoustic feature such as power of speech can be used as the evaluation value S.

If the start is detected by the speech detection unit 8 (“Yes” in step S5 of FIG. 2), the speech recognition unit 9 starts to recognize the signal e (t) of the echo removed speech. Also, the response interruption control unit 11 activates a timer (not illustrated) whose timeout occurs after a predetermined period T passes (step S6 in FIG. 2).

The period T set to the timer as a timeout period by the response interruption control unit 11 may be set to the shortest utterance length of the user 1. For example, the Japanese Patent No. 4282704 suggests that the length may be about 200 ms. The length of reply speech of the user to response speech can be predicted to a certain extent based on content thereof. Thus, a table that associates the period T with each type of response speech of a system may be created so that the period T can be switched by referring to the table in accordance with response speech that changes as the dialog proceeds.

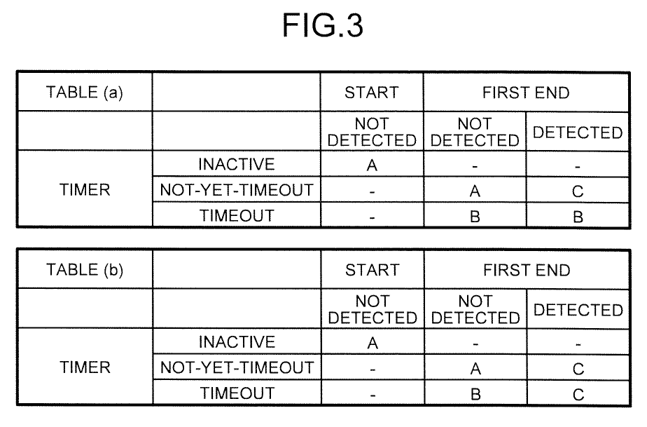

Next, conditional branching illustrated in Table (a) of FIG. 3 is carried out in the response interruption control unit 11 by referring to start/end information from the speech detection unit 8 and the timer status (step S7 in FIG. 2). If a timeout of the timer occurs between the time when the start is detected and the time when the first end is detected (the timer is “Timeout” and the first end is “Not detected” in Table (a) of FIG. 3), that is, if the end is not detected before the period T from the detection of the start passes (“B” in step S7 of FIG. 2), the response interruption control unit 11 sends a response interruption command to the dialog control unit 3 determining that the period is a speech period whose length exceeds that of the period T. Upon receipt of the response interruption command, the dialog control unit 3 causes the response speech output unit 4 to interrupt output of response speech (step S9 in FIG. 2).

If a timeout of the timer occurs at the time when the first end, which is detected after detection of the start, is detected (the timer is “Timeout” and the first end is “Detected” in Table (a) of FIG. 3), that is, if the end is detected at the time when the period T has just passed from the detection of the start (“B” in step S7 of FIG. 2), the response interruption control unit 11 sends a response interruption command to the dialog control unit 3 determining that the period is a speech period whose length is equal to that of the period T. Upon receipt of the response interruption command, the dialog control unit 3 causes the response speech output unit 4 to interrupt output of response speech (step S9 in FIG. 2).

If a timeout of the timer has not occurred when the first end, which is detected after detection of the start, is detected (the timer is “Not-yet-timeout” and the first end is “Detected” in Table (a) of FIG. 3), that is, if the end is detected before the period T from the detection of the start passes (“C” in step S7 of FIG. 2), the speech recognition unit 9 stops recognition of the signal e (t) of echo removed speech determining that the period is a noise period whose length is less than that of the period T. The response interruption control unit 11 stops the timer (step S8 in FIG. 2).

Otherwise, processing proceeds without doing anything (“A” in step S7 of FIG. 2). As described above, response speech can be prevented from being unintentionally interrupted by sudden noise whose length is less than that of the period T.

Subsequently, if the end is determined by the speech detection unit 8 (“Yes” in step S10 of FIG. 2), the speech recognition unit 9 terminates recognition of the signal e (t) of echo removed speech and outputs a recognition result (step S11 in FIG. 2). That is, the speech recognition unit 9 operates to recognize speech in the range sandwiched between the latest start and end of the signal e (t) of echo removed speech and output a recognition result.

Upon receipt of the recognition result of the speech recognition unit 9, the dialog control unit 3 causes the response speech output unit 4 to stop response speech output. Furthermore, the dialog control unit 3 stops speech input of the speech input unit 6 and the operation of the echo cancel unit 10 linked thereto, performs a service/process for the user 1 in accordance with the recognition result, and proceeds with the dialog sequence (step S12 in FIG. 2).

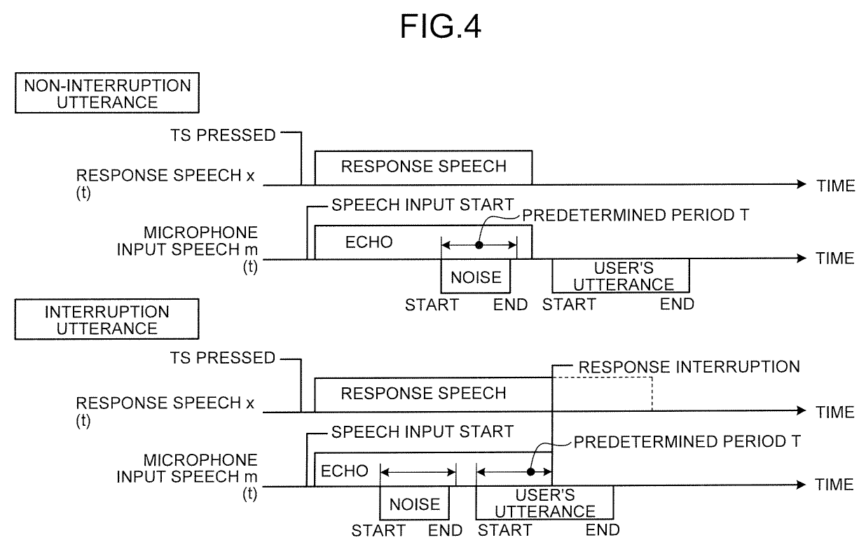

Thus, a speech dialog apparatus according to the embodiment operates in such a way that output of response speech is interrupted if the end is just detected or is not yet detected when the period T measured by a timer passes after the start is detected. As a result, as illustrated in FIG. 4, an unintentional interruption of response due to sudden noise whose length is less than the period T can be prevented.

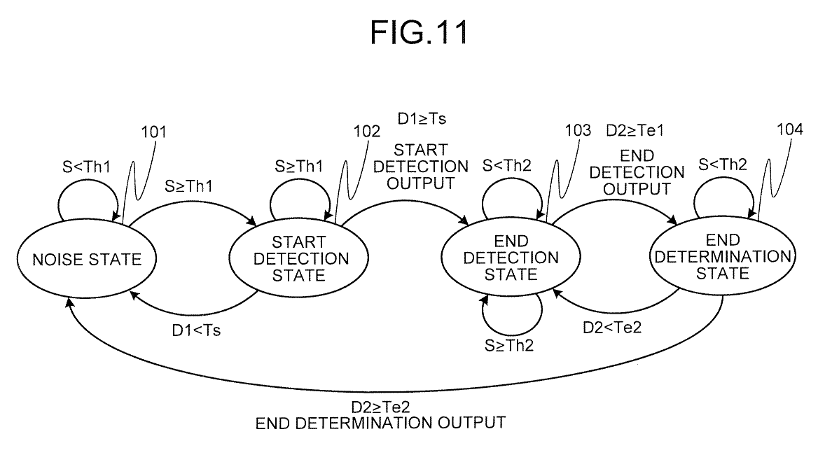

Incidentally, the speech detection unit 8 detects or determines the start/end of speech by an automaton illustrated in FIG. 11. More specifically, assume that a noise state 101 is set as the initial state of the automaton and the automaton makes a transition from the noise state 101 to a start detection state 102 when the evaluation value S becomes a start detection threshold Th1 or more.

In the start detection state 102, if a period D1 in which the evaluation value S is equal to or greater than the threshold Th1 continues for a start detection time Ts, the speech detection unit 8 detects the start time of the period D1 as the start of the speech interval and outputs start/end information indicating that the start is detected. Then, the automaton makes a transition to an end detection state 103. Conversely, if the period D1 does not continue for the start detection time Ts, the automaton is brought back to the noise state 101.

In the end detection state 103, if a period D2 in which the evaluation value S falls below an end detection threshold Th2 continues for an end detection time Te1 or longer, the speech detection unit 8 detects the start time of the period D2 as the end of the speech interval and immediately outputs start/end information indicating that the end is detected. Then, the automaton makes a transition from the end detection state 103 to an end determination state 104.

In the end determination state 104, if the period D2 further continues for an end determination time Te2 (>Te1) or longer, the speech detection unit 8 determines that the previously detected end is the end and outputs start/end information indicating that the end is determined. Then, the automaton makes a transition to the initial noise state 101. Conversely, if the period D2 does not continue for the end determination time Te2 or longer, the automaton is brought back to the previous end detection state 103. As a result, the end may be detected a plurality of times between the start detection and end determination.

Thus, the start/end information output by the speech detection unit 8 is output in the order of the start detection (the transition from the start detection state 102 to the end detection state 103), end detection (the transition from the end detection state 103 to the end determination state 104, which may occur a plurality of times in some cases), and end determination (the transition from the end determination state 104 to the noise state 101) and at least delays in accordance with Ts, Te1, and Te2 arise therebetween, respectively.

The flow of processing in FIG. 2 will be described in each state as follows.

Before the start is detected, the processing proceeds like S3→S4→S5→S7→S10→S3. At this point, the start is not yet detected and the timer is also not activated ands thus, the processing always proceeds to “A” from S7.

If the processing proceeds to “Yes” after the start is detected in S5, the timer is activated in S6 and speech recognition is also started. Hereinafter, speech recognition continues until the speech recognition is stopped.

After the start is detected, the processing proceeds again like S3→S4→S5→S7→S10→S3 until the first end is detected or a timeout of the timer occurs.

The timer has been activated at this point. If a timeout of the timer occurs between the time when the start is detected and the time when the first end is detected, the processing branches to “B” in S7 so that the processing proceeds like S9→S3 determining that the detected speech sandwiched between the start and end is a speech whose length exceeds that of the period T.

If a timeout of the timer has not yet occurred when the first end is detected after the start is detected, the processing branches to “C” in S7 and the timer and speech recognition are stopped in S8 to wait for detection of a new start again determining that the detected speech sandwiched between the start and end is noise whose length is less than that of the period T. At this point, the automaton in FIG. 11 makes a transition from the end detection state 103 to the noise state 101 (not illustrated). Then, the processing proceeds like S3→S4→S5→S7→S10→S3 again.

If a timeout of the timer occurs at the time when the first end is detected after the start is detected, the processing similarly branches to “B” in S7 so that the processing proceeds like S9→S3 determining that the detected speech sandwiched between the start and end is a speech whose length is equal to that of the period T.

Thus, the interruption of response speech is decided based on whether the elapsed time between the detection of the start and the detection of the first end is longer or shorter than the predetermined period T. The end determination needs an extra time of Te2=Te1 when compared with the end detection. A faster response speed is ensured by performing a response interruption determination at the time when the first end is detected.

In consideration of the possibility that the detected start/end is discarded as noise, a recognition result is configured to be output after waiting until the end is determined. The processing in this case proceeds like S3-22 S4→S5→S7→S10→S11→S12.

Furthermore, conditional branching illustrated in Table (b) of FIG. 3 may be carried out at step S7 in FIG. 2. In this case, if a timeout of the timer occurs at the time when the first end is detected, the processing is caused to branch to “C”, instead of “B” according to Table (a) of FIG. 3. As a result, the speech dialog apparatus operates in such a way that output of response speech is interrupted only if the end is not yet detected when the period T measured by the timer passes from the detection of the start.

The difference between Table (a) and Table (b) in FIG. 3 is whether to interrupt the response if the end is just detected when the period T measured by the timer passes from the detection of the start. In both cases, if the end is not yet detected when the period T measured by the timer passes from the detection of the start, output of response speech is interrupted.

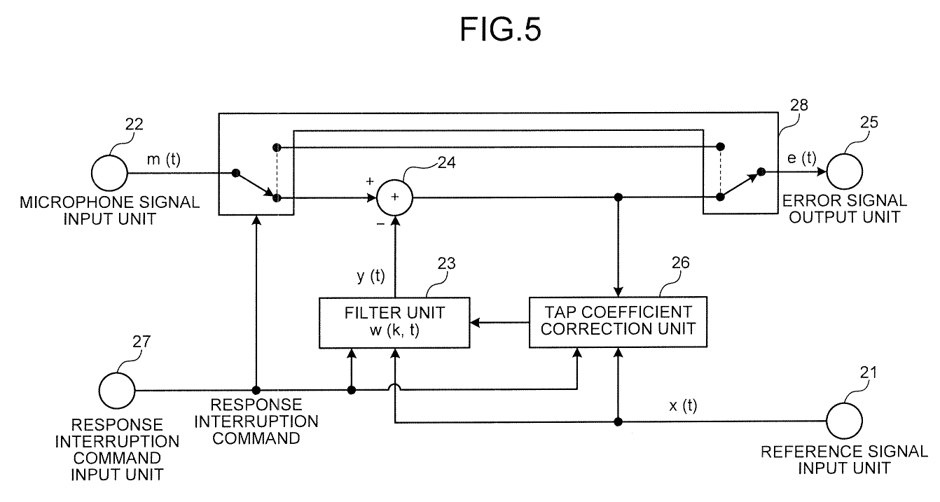

Next, the echo cancel unit 10 will be described. FIG. 5 is a diagram illustrating the configuration of the echo cancel unit 10.

A microphone signal m (t) input by a microphone signal input unit 22 is the signal m (t) of microphone input speech from the speech input unit 6. A reference signal x (t) input by a reference signal input unit 21 is the signal x (t) of response speech from the response speech output unit 4. An error signal e (t) output by an error signal output unit 25 is the signal e (t) of echo removed speech to be output by the echo cancel unit 10. A response interruption command input by a response interruption command input unit 27 is the response interruption command from the response interruption control unit 11.

The echo cancel unit 10 includes a filter unit 23 that imitates transfer characteristics of an echo path from the speaker 5 to the microphone 7 in FIG. 1. The filter unit 23 is composed of a finite impulse response filter (FIR filter) of a tap number N. An echo replica signal y (t) is generated, according to Formula 2, by convolution of a tap coefficient w (k, t) of the filter unit 23 into the reference signal x (t), where y (t) is the value of an echo replica signal, w (k, t) is the value of the k-th tap coefficient of the filter unit 23 at time t, and x (t−k) is the value of a reference signal at a time going back by time k from time t. N denotes the number of tap coefficients and is called the tap number or filter length. W (t) and X (t) are a column vector in which the tap coefficients w (k, t) are arranged when k is changed from 0 to N−1 and a column vector in which the reference signals x (t−k) are arranged, respectively.

The echo replica signal y (t) is a signal imitating an echo of response speech mixed in the microphone signal m (t). The error signal e (t) from which an echo is removed can be generated, according to Formula 1, by subtracting the echo replica signal y (t) from the microphone signal m (t) using a subtracter 24. By outputting the error signal e (t) from the error signal output unit 25, the echo cancel unit 10 can send the signal e (t) of echo removed speech to the subsequent stage.

Echo cancel output calculation formulas are represented by Formula 1 and Formula 2.

$$\begin{matrix}e ( t ) = m ( t ) - y ( t ) & ( 1 ) \\ \begin{matrix}y ( t ) = {\sum }_{k = 0}^{N - 1} ( w ( k , t ) \cdot x ( t - k ) ) \\ = {W ( t )}^{T} X ( t )\end{matrix} & ( 2 )\end{matrix}$$

where W (t) and X (t) are represented by column vectors in Formula 3.

W(t)=[w(0,t),w(1,t), . . . w(N−1,t)]^{T}

X(t)=[x(t),x(t−1), . . . x(t−N+1)]^{T} (3)

If transfer characteristics of the echo path from the speaker 5 to the microphone 7 are correctly provided to the filter unit 23 by preparations in advance, there is no need to execute an adaptive algorithm described later. However, in an operating environment in which transfer characteristics of the echo path change every minute, the adaptive algorithm that asymptotically finds correct transfer characteristics based on observed signals needs to be executed.

As a group of adaptive algorithms, the stochastic gradient algorithm that corrects the tap coefficient in the gradient (called the stochastic gradient) direction of an instantaneous square error e² (t) regarding the tap coefficient is known. The tap coefficient correction formula of the stochastic gradient algorithm can be generalized by a recurrence formula of Formula 4 by setting the instantaneous value of an error signal at time t as e (t).

W(t+1)=W(t)+μ·γ·G(e(t))·X(t) (4)

where the positive number γ is a normalization coefficient, the positive number μ is a step size to control the scale of correction, and G (e (t)) is a function of the instantaneous value e (t), each of which is a scalar quantity. The second term of the right-hand side of Formula 4 represents the amount of a coefficient correction indicating how much to correct the tap coefficient value W (t) at time t. A tap coefficient correction unit 26 in FIG. 4 performs correction processing of the tap coefficient according to Formula 4.

An algorithm obtained by applying a function G defined in Formula 5 and the normalization coefficient γ to Formula 4 is the NLMS algorithm (normalized LMS algorithm).

$$G ( e ( t ) ) = e ( t ) \\ γ = \frac{1}{{X}^{T} X} \qquad ( 5 )$$

where X^{T}X is the summation of power of N reference signal values from the current time to the (N−1) past. The NLMS algorithm is an algorithm that asymptotically determines the tap coefficients that minimize the mean-square value of error signals by using the instantaneous value e (t) of error at each time.

However, generation of the echo replica signal y (t) by Formula 2 and corrections of the tap coefficients by Formula 3 described above require a lot of computation costs. On the other hand, operations including Formula 1 to determine the error signal e (t) are needed only when response speech is output, that is, an echo of response speech is present. Thus, if response speech is interrupted, it is desirable to stop operations of at least Formula 1 and Formula 2 and if the tap coefficients are being corrected adaptively, it is desirable to further stop operations of Formula 3.

Thus, when a response interruption command from the response interruption control unit 11 is received via the response interruption command input unit 27, the filter unit 23 stops operations of Formula 2, the subtracter 24 stops operations of Formula 1, and the tap coefficient correction unit 26 stops operations of Formula 3.

However, the error signal e (t) output by the error signal output unit 25 will be indefinite after operations are stopped and thus, switching is performed by a signal switching unit 28 so that the microphone signal m (t) is output as the error signal e (t). Processing in this manner causes no problem because an echo of response speech is not superimposed on the microphone signal m (t) after the response speech being interrupted.

By stopping operations of echo cancel processing in the echo cancel unit 10 as described above, after the response speech being interrupted, the period in which echo cancel processing and speech recognition processing proceed concurrently can be suppressed to the period T. By making the period T shorter, a situation can more easily be created in which an arithmetic unit capable of performing one of the processing that is more time-consuming is applied. An advantage of being able to use arithmetic units of lower capabilities is thereby obtained so that apparatuses can be provided at lower prices.

Otherwise, the period in which echo cancel processing by the echo cancel unit 10 and speech recognition processing by the speech recognition unit 9 proceed concurrently will extend and computation costs will be the sum of both. As a result, a more expensive arithmetic unit having higher capabilities to perform both pieces of processing in real time will be needed.

Incidentally, the embodiment can be practiced in various modified forms.

For example, it is possible to allow the user to select the interruption method of response speech from a plurality of choices including the above interruption method in accordance with the operating environment or preferences of the user.

For example, if there is almost no noise in an operating environment of a speech dialog apparatus, erroneous detection due to noise is considered to occur very rarely. Thus, if, like conventional technology, the response interruption control unit 11 interrupts response speech when the start is detected, an advantage of being able to eliminate the period in which echo cancel processing and speech recognition processing proceed concurrently, that is, to reduce computation costs as much as possible is obtained. On the other hand, a case where there is sufficient arithmetic proficiency and there is no need to interrupt response speech according to preferences of the user can be considered. In this case, if the response interruption control unit 11 interrupts response speech when the end is determined, the user can continue to listen to the response speech until the user ceases to talk.

### Second Embodiment

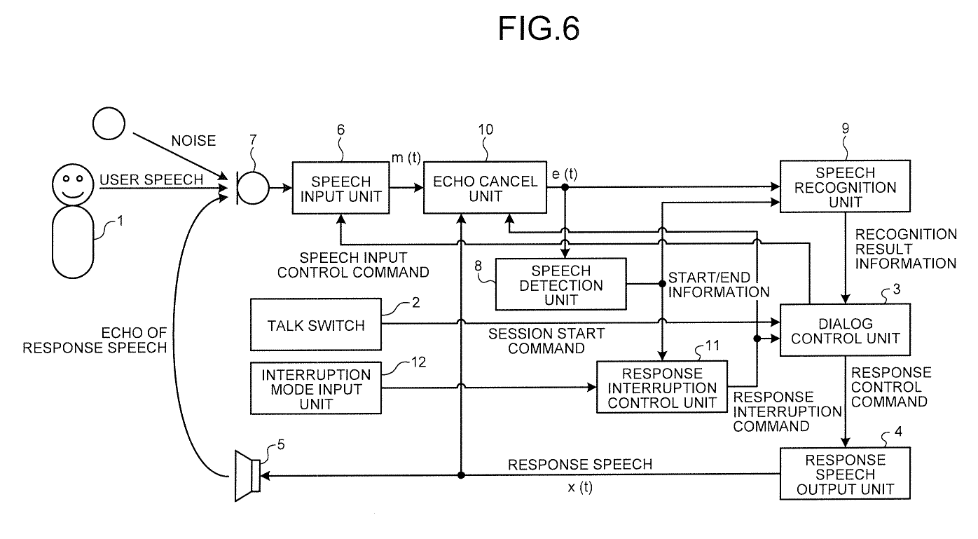

As illustrated in FIG. 6, an interruption mode input unit 12 may newly be provided in the embodied apparatus of FIG. 1 so that the operation thereof can be changed in accordance with the operating environment or preferences of the user. The user 1 selects one mode from among a first interruption mode in which a response interruption command is output when the start is detected, a second interruption mode in which, as described above, a response interruption command is output if the end is not yet detected when the period T passes after the start is detected, and a third interruption mode in which a response interruption command is output when the end is determined via the interruption mode input unit 12 in order to set the selected mode as the interruption mode of the response interruption control unit 11.

The flow of processing in interruption mode 2 is as illustrated in FIGS. 2 and 3. The user 1 may be enabled to set the value of the period T via the interruption mode input unit 12.

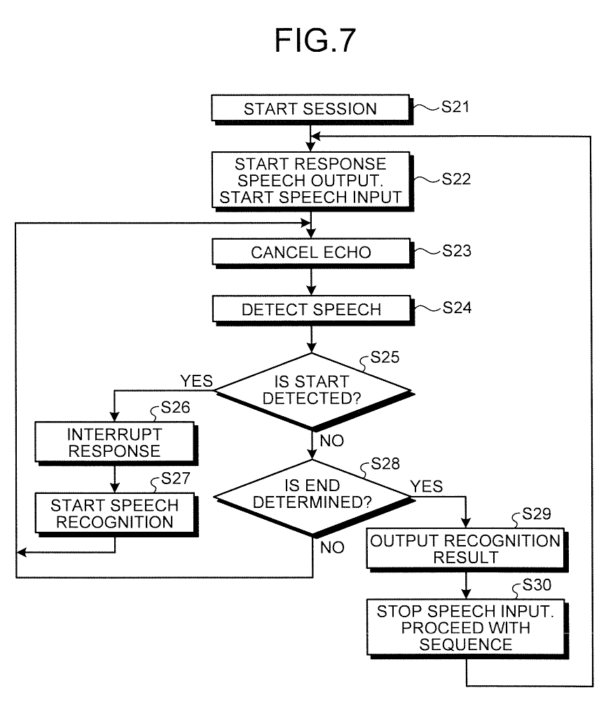

Next, the flow of processing in interruption mode 1 is illustrated in FIG. 7.

When the talk switch 2 is pressed by the user 1 and a session start command is sent to the dialog control unit 3 (step S21 in FIG. 7), the dialog control unit 3 sends, as needed and in accordance with a dialog sequence, a response control command instructing output of response speech toward the user 1 to the response speech output unit 4.

Upon receipt of the command, the response speech output unit 4 generates the signal x (t) of the instructed response speech. The signal x (t) is amplified and output from the speaker 5 toward the user 1.

At this point, the dialog control unit 3 sends a speech input control command instructing the start of speech input to the speech input unit 6. Upon receipt of the command, the speech input unit 6 starts speech input via the microphone 7 so that speech uttered by the user 1 can be input (step S22 in FIG. 7).

In conjunction with the input of speech by the speech input unit 6, the echo cancel unit 10 generates and outputs the signal e (t) of echo removed speech obtained by canceling (removing) an echo of the signal x (t) of response speech from the signal m (t) of microphone input speech by the speech input unit 6 (step S23 in FIG. 7).

The speech detection unit 8 calculates the evaluation value S from the signal e (t) of echo removed speech by the echo cancel unit 10 to determine whether the user 1 has uttered based on the evaluation value S. If the start or end of speech uttered by the user 1 is detected, the speech detection unit 8 also sends start/end information to the speech recognition unit 9 and the response interruption control unit 11 (step S24 in FIG. 7). An acoustic feature such as power of speech can be used as the evaluation value S.

When start/end information indicating the start detection is output by the speech detection unit 8 (“Yes” in step S25 of FIG. 7), the response interruption control unit 11 sends a response interruption command to the dialog control unit 3. Upon receipt of the response interruption command, the dialog control unit 3 causes the response speech output unit 4 to interrupt output of the response speech (step S26 in FIG. 7). Moreover, the speech recognition unit 9 starts recognition of the signal e (t) of echo removed speech (step S27 in FIG. 7).

Then, when start/end information indicating the end determination is output from the speech detection unit 8 (right branching in step S28 of FIG. 7), the speech recognition unit 9 terminates recognition of the signal e (t) of echo removed speech and outputs a recognition result (step S29 in FIG. 7). That is, the speech recognition unit 9 operates in such a way that speech in the range sandwiched between the start and end of the signal e (t) of echo removed speech is recognized and a result thereof is output.

Upon receipt of the recognition result of the speech recognition unit 9, the dialog control unit 3 causes the response speech output unit 4 to stop response speech output. Furthermore, the dialog control unit 3 stops speech input of the speech input unit 6 and the operation of the echo cancel unit 10 linked thereto, performs a service/process for the user 1 in accordance with the recognition result, and proceeds with the dialog sequence (step S30 in FIG. 7).

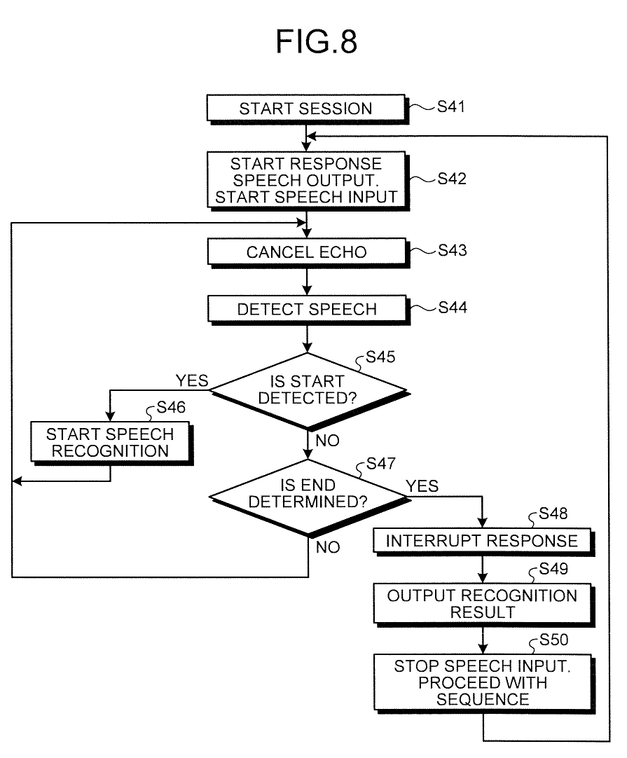

Next, the flow of processing in interruption mode 3 is illustrated in FIG. 8.

When the talk switch 2 is pressed by the user 1 and a session start command is sent to the dialog control unit 3 (step S41 in FIG. 8), the dialog control unit 3 sends, as needed and in accordance with a dialog sequence, a response control command instructing output of response speech toward the user 1 to the response speech output unit 4.

Upon receipt of the command, the response speech output unit 4 generates the signal x (t) of the instructed response speech. The signal x (t) is amplified and output from the speaker 5 toward the user 1.

At this point, the dialog control unit 3 sends a speech input control command instructing the start of speech input to the speech input unit 6. Upon receipt of the command, the speech input unit 6 starts speech input via the microphone 7 so that speech uttered by the user 1 can be input (step S42 in FIG. 8).

In conjunction with the input of speech by the speech input unit 6, the echo cancel unit 10 generates and outputs the signal e (t) of echo removed speech obtained by canceling (removing) an echo of the signal x (t) of response speech from the signal m (t) of microphone input speech by the speech input unit 6 (step S43 in FIG. 8).

The speech detection unit 8 calculates the evaluation value S from the signal e (t) of echo removed speech by the echo cancel unit 10 to determine whether the user 1 has uttered based on the evaluation value S. If the start or end of speech uttered by the user 1 is detected, the speech detection unit 8 also sends start/end information to the speech recognition unit 9 and the response interruption control unit 11 (step S44 in FIG. 8). An acoustic feature such as power of speech can be used as the evaluation value S.

When start/end information indicating the start detection is output by the speech detection unit 8 (“Yes” in step S45 of FIG. 8), the speech recognition unit 9 starts recognition of the signal e (t) of echo removed speech (step S46 in FIG. 8).

Then, when start/end information indicating the end determination is output from the speech detection unit 8 (“Yes” in step S47 of FIG. 8), the response interruption control unit 11 sends a response interruption command to the dialog control unit 3. Upon receipt of the response interruption command, the dialog control unit 3 causes the response speech output unit 4 to interrupt output of the response speech (step S48 in FIG. 8). Moreover, the speech recognition unit 9 terminates recognition of the signal e (t) of echo removed speech and outputs a recognition result (step S49 in FIG. 8). That is, the speech recognition unit 9 operates in such a way that speech in the range sandwiched between the start and end of the signal e (t) of echo removed speech is recognized and a result thereof is output.

Upon receipt of the recognition result of the speech recognition unit 9, the dialog control unit 3 stops speech input of the speech input unit 6 and the operation of the echo cancel unit 10 linked thereto, performs a service/process for the user 1 in accordance with the recognition result, and proceeds with the dialog sequence (step S50 in FIG. 8).

Embodiments can also be practiced as a computer program that performs processing illustrated in FIG. 2, 3, 7, or 8 executed by the configuration illustrated in FIG. 1 or 6. Also, embodiments can be practiced as a computer readable recording medium in which such a program is recorded.

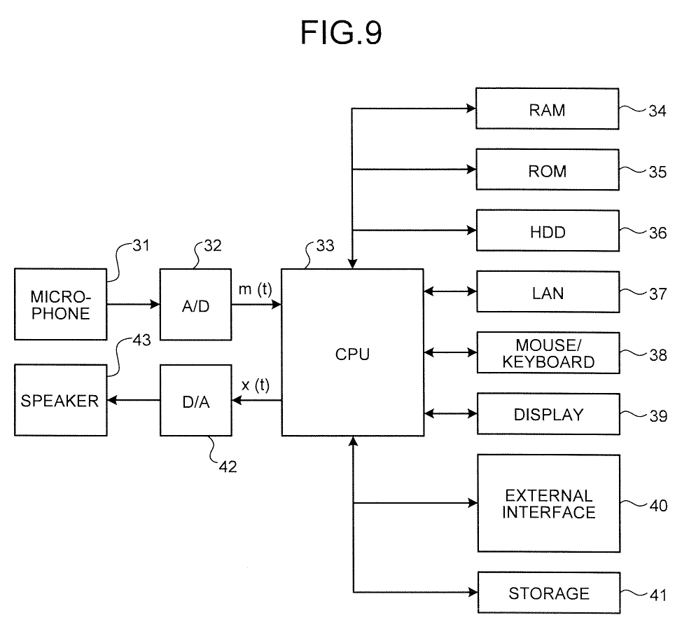

More specifically, as illustrated in FIG. 9, embodiments can be practiced by using a computer. A microphone 31 converts user's speech into an electric acoustic signal. An A/D converter 32 converts the acoustic signal by the microphone 31 into digital acoustic data. A CPU 33 executes program instructions to process the converted digital acoustic data. A RAM 34, a ROM 35, an HDD 36, a LAN 37, a mouse/keyboard 38, and a display 39 are standard devices constructing a computer. An external interface 40 transmits/receives data to/from an external apparatus such as a communication apparatus and service providing apparatus. A storage 41 may be a drive device to supply programs or data to the computer from outside via a storage medium and, more specifically, a CD-ROM drive, floppy (registered trademark) disk drive, CF/SD card slot, USB interface or the like. A D/A converter 42 converts digital acoustic data into an acoustic signal. A speaker 43 amplifies and outputs the acoustic signal and is connected to the D/A converter 42.

The computer stores a speech dialog processing program that executes processing steps illustrated in FIG. 2, 3, 7, or 8 in the HDD 36 and executes the speech dialog processing program by reading the program into the RAM 34 for execution by the CPU 33. In this case, the computer functions as a speech dialog apparatus by using the microphone 31 and the A/D converter 32 for input of the signal m (t) of microphone input speech, using the D/A converter 42 and the speaker 43 for amplified output of the signal x (t) of response speech, and processing the signal m (t) of microphone input speech and signal x (t) of response speech by the CPU 33. The computer can also receive the speech dialog processing program from a recording medium inserted into the other storage 41 or another apparatus connected via the LAN 37. Incidentally, by using the mouse/keyboard 38 and the display 39, the computer can receive operation input of the user or present information to the user.

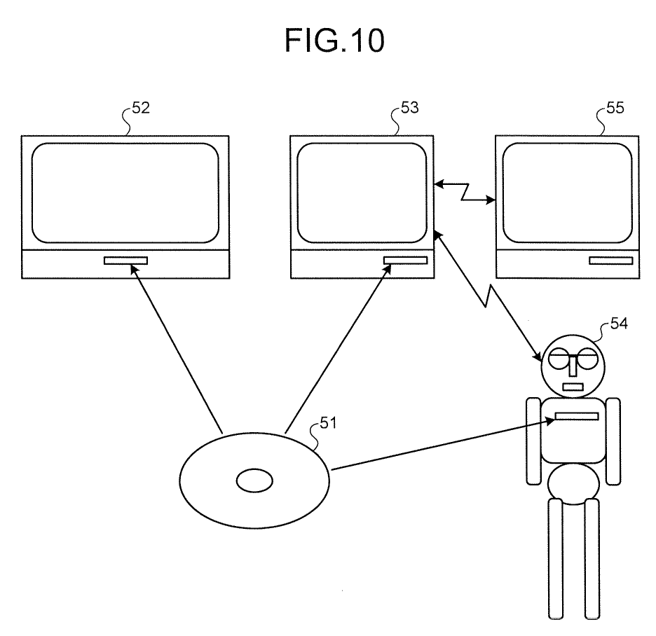

As illustrated in FIG. 10, embodiments can be practiced as a recording medium. A recording medium 51 includes a CD-ROM, CF/SD card, floppy (registered trademark) disk, and USB storage recording a speech dialog processing program according to embodiments. The program can be executed on an electronic apparatus 55 or a robot 54 by inserting the recording medium 51 into an electronic apparatus 52 or 53 or the robot 54 to make the program executable or to supply the program from the electronic apparatus 53 to which the program is supplied to the other electronic apparatus 55 or the robot 54 by communication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech dialog apparatus, comprising:
a speech detection unit that detects a start and an end of echo removed speech obtained by removing an echo of response speech contained in input speech;
a response interruption control unit that outputs a response interruption command if the end is not yet detected when a predetermined period from the detection of the start passes; and
a dialog control unit that causes a response speech output unit to interrupt output of the response speech upon receipt of the response interruption command from the response interruption control unit.

2. The apparatus according to claim 1, further comprising an interruption mode selection unit for selecting one interruption mode from among a first interruption mode in which the response interruption command is output when the start is detected, a second interruption mode in which the response interruption command is output if the end is not yet detected when the predetermined period from the detection of the start passes, and a third interruption mode in which the response interruption command is output when the end is determined, wherein
the response interruption control unit outputs the response interruption command in accordance with the interruption mode selected by the interruption mode selection unit.
